(19) United States
(12) Patent Application Publication
(10) Pub. No.: US 2014/0349070 A1
(43) Pub. Date: Nov. 27, 2014

(54) REFLECTIVE ANODE ELECTRODE FOR USE IN AN ORGANIC ELECTROLUMINESCENT DISPLAY AND METHOD FOR MAKING THE SAME

(71) Applicant: EverDisplay Optronics (Shanghai) Limited, Shanghai (CN)

(72) Inventor: Peiming Chu, Shanghai (CN)

(73) Assignee: EverDisplay Optronics (Shanghai) Limited, Shanghai (CN)

(21) Appl. No.: 13/959,866

(22) Filed: Aug. 6, 2013

(30) Foreign Application Priority Data
May 27, 2013 (CN) 201310202475.4

(51) Int. Cl. H05B 33/28

(52) U.S. Cl. CPC H05B 33/28
USPC 428/142; 428/469; 428/336; 204/192.1

(57) ABSTRACT

Provided is a method for making a reflective anode electrode for use in an organic electroluminescent display, comprising the steps of: sputtering a reflective Ag layer on a substrate in the presence of the inert gas in a first chamber; sputtering a transparent oxide conductive buffer layer on said Ag layer in the presence of the inert gas in a second chamber; and sputtering a transparent oxide conductive contact layer on said buffer layer in the presence of both inert gas and oxygen in the second chamber, to obtain the resulted reflective anode electrode. Also provided is a reflective anode electrode made by above method. The reflective anode electrode according to the present invention has higher reflectance and transmittance, due to the presence of the transparent conductive oxide buffer layer therein, which leads to the oxidation of the reflective layer minimized and the total transmittance substantially not affected.

### CROSS-REFERENCE TO RELATED APPLICATIONS

This application claims the benefit of Chinese Patent Application No. 201310202475.4, filed on May 27, 2013 and entitled “REFLECTIVE ANODE ELECTRODE FOR ORGANIC ELECTROLUMINESCENT DISPLAY AND MAKING METHOD THEREOF”, the content of which is incorporated by reference herein in its entirety.

### TECHNICAL FIELD

The present application relates to the field of organic electroluminescent display, and particularly to a reflective anode electrode for use in an organic electroluminescent display and a method for making the same.

### BACKGROUND

An organic electroluminescent (hereinafter, referred to as “organic EL”) display is a type of self-luminous flat panel display, which has an all solid-state device structure. Organic EL displays are electrically driven devices and have a passive or active driving system. The active matrix-type organic EL display usually has a top-emission structure that comprises a reflective anode electrode, in which a transparent oxide conductive film typically formed of ITO or IZO and a reflective film are stacked together, serving a purpose of reflecting light emitted from the organic EL devices. Silver (Ag) is favorable for use as a reflective film because of high reflectance and conductivity. For example, a multilayer structure having ITO and Ag film has been used as a reflective anode electrode in mass-produced top-emission organic EL displays.

Sputtering has been widely used in the field of organic EL display capable of forming stable, dense, uniform and large film of each layer in the typical laminated-structure organic EL device. Said multilayer reflective anode electrode is usually formed by sputtering an Ag film on the substrate as the reflective layer and subsequently sputtering a transparent oxide conductive film on the Ag film as the anode contact layer. The sputtering of transparent oxide conductive film such as ITO or IZO typically involves a reactive process which needs small amount of oxygen or moisture added to increase the oxygen content and thus improve the transmittance of the film. However, the reflective Ag film formed below can be readily oxidized due to the introduction of oxygen or moisture, and the oxide generated will result in the increased roughness and lowered reflectance of the reflective Ag film.

Currently, a protective film for the Ag film or an Ag alloy film instead of the pure Ag film is usually applied, to minimize the oxidization of the reflective metal film during the reactive sputtering of the oxide film thereon. For example, Chinese Patent Application No. 102168246A discloses depositing a protective Ti layer on an Ag layer to overcome the oxidation issue. However, the Ti layer with lower reflectance compared to the Ag layer may lead to the lowered total reflectance of the whole reflective anode electrode. Moreover, the addition of the chamber incorporated for sputtering the extra Ti layer may raise the complexity and the cost of the process. As another example, Chinese Patent Application No. 102612859A discloses a reflective anode electrode which comprises a Al—Ag alloy layer rather than an Ag layer to relieve the oxidation. Similarly, the application of Ag alloy layer with lower reflectance may decrease the total reflectance of the reflective anode electrode.

Thus, there is still a demand for an improved method for making a reflective anode electrode to minimize the oxidation of the reflective Ag film therein.

### SUMMARY OF THE INVENTION

The present invention has been made in view of the art described hereinabove. It is therefore an object of the invention to provide a method for making a reflective anode electrode for use in an organic electroluminescent display, comprising the steps of:

(1) sputtering a reflective Ag layer on a substrate in the presence of inert gas in a first chamber;

(2) sputtering a transparent oxide conductive buffer layer on said Ag layer in the presence of inert gas in a second chamber; and

(3) sputtering a transparent oxide conductive contact layer on said buffer layer in the presence of both inert gas and oxygen in the second chamber, to obtain the resulted reflective anode electrode.

According to some embodiments, in the steps (1)-(3), the inert gas is each independently selected from the group consisting of Ar, Kr, Xe, Ne and N₂.

According to some embodiments, in the steps 1-3, the inert gas is Ar.

According to some embodiments, in the steps (1) and (2), the flow of the inert gas is in a range from 75 to 200 cm³/min.

According to some embodiments, in the steps (1) and (2), the pressure of the inert gas is in a range from 0.3 to 0.8 Pa.

According to some embodiments, in the step (3), the flow ratio of the inert gas to oxygen is in a range from 50:1 to 100:1.

According to some embodiments, the buffer layer and the contact layer are each composed of ITO.

According to some embodiments, the thickness of the reflective Ag layer is in a range from 100 to 200 nm.

According to some embodiments, the thickness of the reflective Ag layer is 150 nm.

According to some embodiments, the thickness of the transparent oxide conductive buffer layer is in a range from 1 to 5 nm.

According to some embodiments, the thickness of the transparent oxide conductive buffer layer is 3 nm.

According to some embodiments, the thickness of the transparent oxide conductive contact layer is in a range from 10 to 20 nm.

According to some embodiments, the thickness of the transparent oxide conductive contact layer is in a range from 11 nm.

Another object of the present application is to provide a reflective anode electrode made by the above method, comprising a reflective Ag layer, a transparent oxide conductive buffer layer disposed on the Ag layer, and a transparent oxide conductive contact layer disposed on the buffer layer.

According to some embodiments, both the buffer layer and the contact layer of the reflective anode electrode are composed of ITO.

According to some embodiments, the thickness of the reflective Ag layer is in a range from 100 to 200 nm.

According to some embodiments, the thickness of the reflective Ag layer is 150 nm.

According to some embodiments, the thickness of the transparent oxide conductive buffer layer is in a range from 1 to 5 nm.

According to some embodiments, the thickness of the transparent oxide conductive buffer layer is 3 nm.

According to some embodiments, the thickness of the transparent oxide conductive contact layer is in a range from 10 to 20 nm.

According to some embodiments, the thickness of the transparent oxide conductive contact layer is 11 nm.

According to some embodiments, the surface roughness Rₐ of the reflective Ag layer is in a range of 0.78 to 0.92 nm.

According to some embodiments, the total transmittance of ITO buffer layer and ITO contact layer at a wavelength of 550 nm is in a range from 93.8% to 96.2%.

According to the invention, the transparent oxide conductive buffer layer interposed between the reflective Ag layer and the transparent oxide conductive contact layer is directly formed on the Ag layer under the inert gas without oxygen introduced, which protects the reflective Ag layer from oxidizing when oxygen is subsequently introduced to form the transparent oxide conductive contact layer. The reflective anode electrode according to the present invention has a lower surface roughness and a higher reflectance, since there is no oxide layer formed on the surface of the Ag layer. The transparent oxide conductive contact layer formed in the presence of oxygen has a higher transmittance, while the transparent oxide conductive buffer layer formed without oxygen introduced has a lower transmittance. However, the total transmittance of two transparent oxide conductive layers is relatively high, as the thickness of the transparent oxide conductive buffer layer is quite small. Further, the method according to the present invention features a simple operation and a low cost, because the two transparent oxide conductive layers can be successively formed in the same chamber with the same target.

### BRIEF DESCRIPTION OF THE DRAWINGS

FIG. 1 is a flow chart diagram of the method for making a reflective anode electrode for use in organic EL display according to the present invention.

FIG. 2 is a schematic view showing the structure of the reflective anode electrode made according to Example 1 of the present invention.

### DETAILED DESCRIPTION

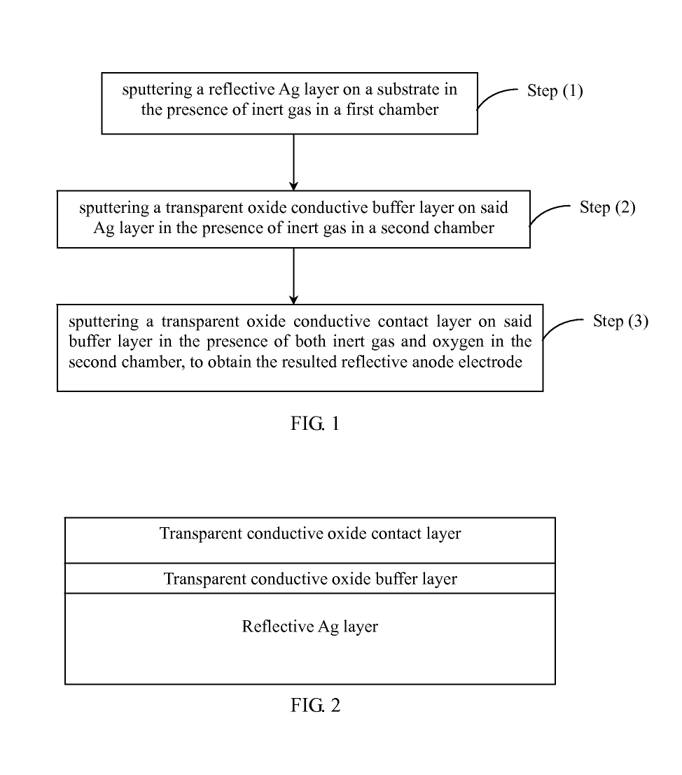

Hereinafter, a method for making a reflective anode electrode according to the present invention will be described with reference to FIG. 1. First, a reflective Ag layer is sputtered on a substrate under inert atmosphere in a first chamber. Then, a transparent oxide conductive buffer layer is sputtered on the formed Ag layer under inert atmosphere in a second chamber. Finally, a transparent oxide conductive contact layer is sputtered on the formed buffer layer in the presence of both inert gas and oxygen in the second chamber. Thereby, a reflective anode electrode is obtained.

According to the present invention, the reflective Ag layer is preferably formed by a DC magnetron sputtering process with the following operation conditions:

Background vacuum degree in the sputtering chamber: 10⁻³ Pa˜10⁻⁵ Pa, and preferably 3×10⁻⁴ Pa;

Type of operation gas: Ar, Kr, Xe, Ne or N₂, and preferably Ar;

Pressure of operation gas: 0.3 Pa˜0.8 Pa, and preferably 0.3 Pa;

Flow of operation gas: preferably 75 cm³/min;

Power of DC source: preferably 610 W;

Pre-heated temperature of the substrate: 25° C.˜200° C., and preferably room temperature;

Target material: Ag with high purity;

Thickness of the reflective Ag layer: 100 nm˜200 nm, and preferably 150 nm.

Due to the low absorptivity to visible light and the excellent conductivity, Ag is favorable for use as the reflective layer of the reflective anode electrode to afford high reflectance and best reflection effect.

When the transparent conductive oxide is deposited on the Ag layer as the anode contact layer, oxygen or moisture is usually introduced into the sputtering chamber to assure that the transparent conductive oxide can possess high transmittance. However, Ag is very sensitive to oxygen and moisture, and can be readily oxidized to form oxide on the surface. Consequently, the oxide will raise the surface roughness and reduce the reflectance. For this purpose, provided herein is a method for making a reflective anode electrode including forming a thin buffer layer directly on the reflective Ag layer, wherein the buffer layer composed of a transparent conductive oxide is deposited under inert atmosphere without oxygen introduced.

According to the present invention, the transparent conductive oxide buffer layer is preferably formed by a DC magnetron sputtering process with the following operation conditions:

Background vacuum degree in the sputtering chamber: 10⁻³ Pa˜10⁻⁵ Pa, and preferably 3×10⁻⁴ Pa;

Type of operation gas: Ar, Kr, Xe, Ne or N₂, and preferably Ar;

Pressure of operation gas: 0.3 Pa˜0.8 Pa, and preferably 0.67 Pa;

Flow of operation gas: preferably 200 cm³/min;

Power of DC source: preferably 610 W;

Pre-heated temperature of the substrate: 25° C.˜200° C., and preferably room temperature;

Target material: conductive oxide ceramic target, and preferably indium tin oxide target (90% of indium oxide, 10% of tin oxide);

Thickness of the buffer layer: 1 nm˜5 nm, and preferably 3 nm.

As no oxygen is introduced during the formation of the buffer layer, the oxidization of the reflective Ag layer below will be minimized. Furthermore, the buffer layer also can protect the reflective Ag layer from oxidizing when oxygen or moisture is introduced for sputtering the conductive oxide contact layer with excellent transmission. Therefore, it is assured that the reflective Ag layer has a lower surface roughness and a higher reflectance.

The sputtering of the transparent conductive oxide typically involves a reaction process. It is believed that the transmission of the transparent conductive oxide can be significantly improved as oxygen content is increased by introducing small amount of O₂. Thus, in order to increase the total transmission of the whole reflective anode electrode, in the method, after the oxide buffer layer with lower transmission is formed only in the presence of the inert gas in the chamber, small amount of oxygen is subsequently introduced to facilitate an oxide contact layer with higher transmission successively formed thereon.

According to the present invention, the transparent conductive oxide contact layer is preferably formed by a DC magnetron sputtering process with the following operation conditions:

Background vacuum degree in the sputtering chamber: 10⁻³ Pa˜10⁻⁵ Pa, and preferably 3×10⁻⁴ Pa;

Type of operation gas: inert gas and oxygen, and preferably Ar and O₂;

Pressure of operation gas: 0.3 Pa˜0.8 Pa, and preferably 0.67 Pa;

Flow of operation gases: 50:1˜100:1 (inert gas:oxygen);

Power of DC source: preferably 610 W;

Pre-heated temperature of the substrate: 25° C.˜200° C., and preferably room temperature;

Target material: conductive oxide ceramic target, and preferably indium tin oxide target (90% of indium oxide, 10% of tin oxide);

Thickness of the contact layer: 10 nm˜20 nm, and preferably 11 nm.

Also provided herein is a reflective anode electrode made by above method, comprising a reflective Ag layer, a transparent conductive oxide buffer layer disposed on the Ag layer, and a transparent conductive oxide contact layer disposed on the buffer layer.

Said reflective anode electrode is arranged with a conductive oxide buffer layer between the Ag layer and the conductive oxide contact layer, which can protect the Ag layer from oxidizing and ensure the Ag layer possesses a high reflectance. Since the buffer layer that is formed under inert atmosphere has a lower transmittance, its thickness must be small enough to assure that the whole reflective anode electrode has a higher transmittance. The thickness of the buffer layer can be in a range from 1 to 5 nm, preferably 3 nm. The thickness of the contact layer can be in a range from 10 to 20 nm, preferably 11 nm. Both of the buffer layer and the contact layer are preferably composed of ITO. Under the protection of the buffer layer, the surface roughness Rₐ of the reflective Ag layer is significantly lowered and can be 0.78˜0.92 nm, while the total transmittance of the transparent conductive oxide layer at a wavelength of 550 nm is not greatly affected by the buffer layer and can be 93.8˜96.2%.

The reflective anode electrode for organic EL display according to the present invention has higher reflectance and transmittance, due to the presence of the transparent conductive oxide buffer layer therein, which leads to the oxidation of the reflective layer minimized and the total transmittance substantially not affected. Further, according to the method of the present invention, both of the transparent conductive oxide buffer layer and the transparent conductive oxide contact layer are made from the same material, such that said two layers can be successively formed in the same chamber with the same target. Thus, the method according to the present invention features a simple process, a low cost and a multilayer structure with good interface combination.

The terms used herein each have usual means appreciated by the skilled person in the art, except otherwise indicated.

The present invention will be described in more detail with reference to the drawings and examples. It should be understood that the examples are provided for illustrating rather than limiting the present application.

### Example 1

In this example, a reflective anode electrode comprising a reflective Ag layer, an ITO buffer layer and an ITO contact layer was formed on a 200 mm×200 mm glass substrate by using a DC magnetron sputtering apparatus (type IS-II, ULVAC, Japan). The fabrication process and operation conditions were described as follows:

(1) sputtering a Ag film with a thickness of 150 nm on the glass substrate in a first chamber as the reflective layer, wherein

a. the background vacuum degree in the first chamber is set to 3×10⁻⁴ Pa;

b. the operation gas is Ar with a purity of 99.999% and a flow of 75 cm³/min;

c. the pressure of the operation gas is set to 0.3 Pa;

d. the power of DC source is set to 610 W;

e. the pre-heated temperature of the substrate is set to room temperature;

f. the target material is pure Ag with a purity of 99.99% (ULVAC, Japan);

(2) sputtering an ITO film with a thickness of 3 nm on the reflective layer in a second chamber as the buffer layer, wherein

a. the background vacuum degree in the first chamber is set to 3×10⁻⁴ Pa;

b. the operation gas is Ar with a purity of 99.999% and a flow of 200 cm³/min;

c. the pressure of the operation gas is set to 0.67 Pa;

d. the power of DC source is set to 610 W;

e. the pre-heated temperature of the substrate is set to room temperature;

f. the target material is ITO ceramic material composed of 90% indium oxide and 10% tin oxide (ULVAC, Japan);

(3) sputtering an ITO film with a thickness of 11 nm on the buffer layer in the second chamber as the contact layer, wherein

a. the background vacuum degree in the first chamber is set to 3×10⁻⁴ Pa;

b. the operation gas is Ar (99.999%) and O₂, and the flow ratio of Ar to O₂ is 100:1;

c. the pressure of the operation gas is set to 0.67 Pa;

d. the power of DC source is set to 610 W;

e. the pre-heated temperature of the substrate is set to room temperature;

f. the target material is ITO ceramic material composed of 90% indium oxide and 10% tin oxide (ULVAC, Japan).

The structure of the resulted reflective anode electrode was shown in FIG. 2. The surface roughness Rₐ of the reflective Ag layer of the reflective anode electrode was measured to be 0.84 nm using atomic force microscope (SEIKO-Nanocute). The total transmittance of two ITO films at a wavelength of 550 nm was measured to be 94.6% using spectrophotometer (U-4100, Hitachi, Japan).

### Comparative Example 1

In this example, a conventional reflective anode electrode only comprising a reflective Ag layer and an ITO contact layer was formed on a 200 mm×200 mm glass substrate by using a DC magnetron sputtering apparatus (IS-II, ULVAC, Japan). The fabrication process and operation conditions were described as follows:

(1) sputtering a Ag film with a thickness of 150 nm on the glass substrate in a first chamber as the reflective layer, wherein

a. the background vacuum degree in the first chamber is set to 3×10⁻⁴ Pa;

b. the operation gas is Ar with a purity of 99.999% and a flow of 75 cm³/min;

c. the pressure of the operation gas is set to 0.3 Pa;

d. the power of DC source is set to 610 W;

e. the pre-heated temperature of the substrate is set to room temperature;

f. the target material is pure Ag with a purity of 99.99% (ULVAC, Japan);

(2) sputtering an ITO film with a thickness of 14 nm on the reflective layer in a second chamber as the contact layer, wherein

a. the background vacuum degree in the second chamber is set to 3×10⁻⁴ Pa;

b. the operation gas is Ar (99.999%) and O₂, and the flow ratio of Ar to

O₂ is 100:1;

c. the pressure of the operation gas is set to 0.67 Pa;

d. the power of DC source is set to 610 W;

e. the pre-heated temperature of the substrate is set to room temperature;

f. the target material is ITO ceramic material composed of 90% indium oxide and 10% tin oxide (ULVAC, Japan).

The surface roughness Rₐ of the reflective Ag layer of the resulted reflective anode electrode was measured to be 1.41 nm using atomic force microscope (SEIKO-Nanocute). The transmittance of the ITO film at a wavelength of 550 nm was measured to be 95.8% using spectrophotometer (U-4100, Hitachi, Japan).

As can be seen from above examples, the presence of thin ITO buffer layer formed between the reflective Ag layer and ITO contact layer under inert atmosphere assures the reflective anode electrode possesses a higher reflectance and has no substantially affect on the total transmittance of the reflective anode electrode. Further, both ITO buffer layer and ITO contact layer are made from the same material, such that said two layers can be successively formed in the same chamber with the same target. Thus, the method according to the present invention features a simple process, a low cost and a multilayer structure with good interface combination.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method for making a reflective anode electrode for use in an organic electroluminescent display, comprising the steps of:
(1) sputtering a reflective Ag layer on a substrate in the presence of the inert gas in a first chamber;
(2) sputtering a transparent oxide conductive buffer layer on said Ag layer in the presence of the inert gas in a second chamber; and
(3) sputtering a transparent oxide conductive contact layer on said buffer layer in the presence of both inert gas and oxygen in the second chamber, to obtain the resulted reflective anode electrode.

2. The method according to claim 1, wherein, in the steps (1)-(3), inert gas is each independently selected from the group consisting of Ar, Kr, Xe, Ne and N₂.

3. The method according to claim 2, wherein, in the steps (1)-(3), the inert gas is Ar.

4. The method according to claim 1, wherein, in the steps (1) and (2), the flow of the inert gas is in a range from 75 to 200 cm³/min.

5. The method according to claim 1, wherein, in the steps (1) and (2), the pressure of the inert gas is in a range from 0.3 to 0.8 Pa.

6. The method according to claim 1, wherein, in the step (3), the flow ratio of the inert gas to oxygen is in a range from 50:1 to 100:1.

7. The method according to claim 1, wherein the buffer layer and the contact layer are each composed of ITO.

8. The method according to claim 1, wherein the thickness of the reflective Ag layer is in a range from 100 to 200 nm.

9. The method according to claim 8, wherein the thickness of the reflective Ag layer is 150 nm.

10. The method according to claim 1, wherein the thickness of the transparent oxide conductive buffer layer is in a range from 1 to 5 nm.

11. The method according to claim 10, wherein the thickness of the transparent oxide conductive buffer layer is 3 nm.

12. The method according to claim 1, wherein the thickness of the transparent oxide conductive contact layer is in a range from 10 to 20 nm.

13. The method according to claim 12, wherein the thickness of the transparent oxide conductive contact layer is in a range from 11 nm.

14. A reflective anode electrode made by the method according to claim 1, comprising a reflective Ag layer, a transparent oxide conductive buffer layer disposed on the Ag layer, and a transparent oxide conductive contact layer disposed on the buffer layer.

15. The reflective anode electrode according to claim 14, wherein both the buffer layer and the contact layer of the reflective anode electrode are composed of ITO.

16. The reflective anode electrode according to claim 14, wherein thickness of the reflective Ag layer is in a range from 100 to 200 nm.

17. The reflective anode electrode according to claim 14, wherein the thickness of the reflective Ag layer is 150 nm.

18. The reflective anode electrode according to claim 14, wherein the thickness of the transparent oxide conductive buffer layer is in a range from 1 to 5 nm.

19. The reflective anode electrode according to claim 18, wherein the thickness of the transparent oxide conductive buffer layer is 3 nm.

20. The reflective anode electrode according to claim 14, wherein the thickness of the transparent oxide conductive contact layer is in a range from 10 to 20 nm.

21. The reflective anode electrode according to claim 20, wherein the thickness of the transparent oxide conductive contact layer is 11 nm.

22. The reflective anode electrode according to claim 14, wherein the surface roughness Rₐ of the reflective Ag layer is in a range of 0.78 to 0.92 nm.

23. The reflective anode electrode according to claim 14, wherein the total transmittance of ITO buffer layer and ITO contact layer at a wavelength of 550 nm is in a range from 93.8% to 96.2%.
